(19) United States
(12) Patent Application Publication
(10) Pub. No.: US 2023/0345967 A1
(43) Pub. Date: Nov. 2, 2023

(54) PROCESS FOR THE PREPARATION OF A FIBROUS PRODUCT

(71) Applicant: FrieslandCampina Nederland B.V., Amersfoort (NL)

(72) Inventors: Rianne Maria Allegonda Hendrika VAN DER POL, Wageningen (NL); Mohit HANS, Wageningen (NL); Susan VAN OTTERLOO, Wageningen (NL)

(21) Appl. No.: 17/801,608

(22) PCT Filed: Feb. 2, 2022
(86) PCT No.: PCT/EP2021/052411

§ 371 Date: Aug. 23, 2022

(30) Foreign Application Priority Data
Feb. 27, 2020 (EP) 20159861.2

(51) Int. Cl. A23J 3/08; A23J 3/22; A23L 29/256; A23L 29/00; A23L 3/36

(52) U.S. Cl. CPC A23J 3/08; A23J 3/227; A23L 29/256; A23L 29/015; A23L 3/36

(57) ABSTRACT

Process for the preparation of a fibrous product comprising protein, which process comprises the steps of (a) preparing a homogenous mixture of protein material comprising milk protein material, a hydrocolloid which precipitates with metal cations, and water in the presence of a calcium complex-forming agent at a temperature between 50° C. and 90° C.; (b) adding a solution of a metal cation with a valency of at least 2 to the mixture obtained in step (a) in order to form the fibrous product; (c) isolating the fibrous product; (d) cooling the fibrous product, wherein in step (d) the fibrous product is cooled to a temperature below 10° C., preferably between 0 and 7° C., by vacuum cooling. The product thus obtained is particularly suitable for use in preparing meat substitute products.

### FIELD OF THE INVENTION

The invention relates to a process for the preparation of a fibrous product comprising protein, at least part of which is a milk protein material, which fibrous product is particularly suitable for preparing meat substitute products.

### BACKGROUND TO THE INVENTION

Meat substitute products become more and more accepted as part of the diet of humans. With the increased acceptance of meat substitute products the demand for such products increases accordingly and hence the need for good quality starting products and efficient production methods which enable the manufacture of high quality meat substitute products at commercial scale.

WO 03/061400 A1 discloses a method for the preparation of a fibrous product which is suitable as meat substitute product and which comprises protein. In this method a protein material comprising milk protein material, a hydrocolloid which precipitates with metal cations and water are added together and formed into a homogenous mixture in the presence of a calcium complex forming agent, this mixture is subsequently mixed with a solution of a metal cation having a valency of at least 2 to form a fibrous product and the fibrous product is then isolated. This fibrous product is finished, suitably by washing, pressing and a preservation treatment into the final meat substitute product. Throughout the method according to WO 03/061400 A1 the temperature is kept at 20 to 90° C., most suitably around 50° C. Of course the end product will have to be cooled in the end, but no specific information is disclosed in this respect. Examples of suitable milk protein materials disclosed in WO 03/061400 A1 are cheese curd, cheese, sodium caseinate, whey protein concentrate and powdered milk. The calcium complex forming agent suitably is a phosphate material.

WO 2005/004624 A1 discloses a further embodiment of the method disclosed in WO 03/061400 A1 which would enable an improved controllability of the method. In the method according to WO 2005/004624 A1 the homogenous mixture prepared from milk protein material, a hydrocolloid which precipitates with metal cations, water and a calcium complex forming agent is first given a three-dimensional shape before it is contacted with the solution of a metal cation having a valency of at least 2 to form a product comprising precipitated hydrocolloid.

It is an object of the present invention to provide an optimized method for preparing a fibrous product that can be processed into a meat substitute product of at least the same high quality as existing production methods, such as the production methods disclosed in WO 03/061400 A1 and WO 2005/004624 A1 described above. More specifically, the present invention aims to provide a process with a shorter overall processing time and hence increased production volumes per unit of time using equipment of the same production capacity.

### SUMMARY OF THE INVENTION

It was found that the objects described above can be realized by applying a specific cooling step after isolation of the fibrous product that is formed by adding a solution of a metal cation with a valency of at least 2 to a homogenous mixture of a protein material, a hydrocolloid, water and a calcium complex-forming agent. Surprisingly, the application of such cooling step resulted in fibrous products of excellent quality with an improved shelf-life.

### DETAILED DESCRIPTION

Accordingly, the present invention relates to a process for the preparation of a fibrous product comprising protein, which process comprises the steps of
(a) preparing a homogenous mixture of protein material comprising milk protein material, a hydrocolloid which precipitates with metal cations, and water in the presence of a calcium complex-forming agent at a temperature between 50° C. and 90° C.;
(b) adding a solution of a metal cation with a valency of at least 2 to the mixture obtained in step (a) in order to form the fibrous product;
(c) isolating the fibrous product;
(d) cooling the fibrous product,
   wherein in step (d) the fibrous product is cooled to a temperature below 10° C., preferably between 0 and 7° C., by vacuum cooling.

Vacuum cooling is a well known technique and involves cooling a product under pressures lower than atmospheric pressure. Vacuum cooling works on the principle of latent heat of evaporation to remove the sensible heat of cooled products. The quantity of the heat removed from the product is directly related to the amount of water evaporated from the products. The water in the product starts to boil at relatively low temperature and starts to evaporate from the product, thereby taking the heat from the product which is thus cooled. For vacuum cooling to work, the product to be cooled needs to be sufficiently porous and should contain at least some free water around it, which is the case with the fibrous product prepared according to the method of the invention.

It was found that vacuum cooling enables an effective and rapid cooling of the fibrous product after formation (step (b)) and isolation (step (c)) and hence leads to a reduction of overall processing time. Surprisingly it was found that such rapid cooling by means of vacuum cooling also improves the shelf-life of the final fibrous product as compared with the application of a conventional cooling step. Such conventional cooling would typically involve placing the fibrous product to be cooled in a cooling cell that is kept at the desired end temperature and/or by blowing cold air over the warm fibrous product (air blast cooling). Such conventional cooling treatments would typically take at least several hours.

Without wishing to be bound by any particular theory it is believed that the rate at which moisture is removed from the fibrous product during cooling is an important parameter for the quality of the ultimate fibrous product. This moisture removal rate is considered to be relevant, because it should be avoided that the fibers become too brittle or frozen as a result of the cooling treatment, as this would have an adverse effect on the fibrous structure and hence on product characteristics. A too high moisture removal rate would lead to very brittle fibers that easily break, whilst a too rapid cooling may lead to frozen fibers having the same problem of brittleness. The vacuum cooling treatment was found to lead to fibers having an excellent structure and product characteristics which are at least equally good as fibers obtained via cooling in a conventional way. Moreover, it was found that the vacuum cooled fibrous product has a surprisingly long shelf life as compared with a conventionally cooled fibrous product. The vacuum cooling treatment thus seems to provide the right balance between speed of cooling and moisture removal rate.

Suitable vacuum coolers are widely available in the market and can be obtained from a variety of suppliers. Since it concerns food products, the vacuum cooler used should have been designed in accordance with hygienic design principles, suitably in accordance with the EHEDG Guidelines (EHEDG stands for European Hygienic Engineering & Design Group, see EHEDG Guidelines, DOC 8, Hygienic Design Principles, third edition, March 2018). For the purpose of the present invention it was found particularly suitable to use a vacuum cooler that is capable of reducing the pressure in the cooling chamber to mbar or below, suitably in the range of from 6 to 11 mbar, so that the fibrous product can be effectively cooled to a temperature below 10° C., suitably between 0 and 7° C. within a relatively short time span. Excellent results have been obtained when applying a pressure of 8 to 10 mbar in the cooling chamber.

Cooling time, i.e. the time it takes to cool the fibrous product after isolation to a temperature below 10° C. depends on several factors. A very important factor is the mass of the fibrous product to be cooled. At the same pressure in the cooling chamber of the vacuum cooler and at the same starting temperature a high mass will take longer to cool than a low mass. For the purpose of the present invention it was found that when using commercial quantities, such as 100 to 300 kg per batch of fibrous material, cooling times of up to 50 minutes are achievable when using vacuum cooling. We found that a good balance between speed of cooling and moisture removal rate is obtained when applying such conditions during vacuum cooling that it takes approximately 30 seconds to 2 minutes to cool down 10 kg of fibrous material with 35° C. to a temperature below 10° C. (i.e. average cooling rate of about 8.5 to 35 seconds to cool 10 kg of fibrous material with 10° C., s/10 kg/10° C.). The average cooling rate as used herein is, accordingly, defined as the average time it takes to reduce the temperature of 10 kg of fibrous material with 10° C. Accordingly, conditions during vacuum cooling are suitably such that average cooling rate of the fibrous material is in the range of from 8.5 to 35 s/10 kg/10° C., whereas in a preferred embodiment conditions during vacuum cooling are such that average cooling rate of the fibrous material is in the range of from 15 to 30 s/10 kg/10° C. So for example, cooling down 200 kg of fibrous material from 42° C. to 7° C. in about 30 minutes (average cooling rate of 25.7 s/10 kg/10° C.) would be an excellent average cooling rate.

Other factors that may impact cooling rate are, for example, surface/volume ratio of the mass to be cooled or, in other words, the shape of the mass of fibrous material to be cooled. In general, the higher the surface/volume ratio, the easier water can evaporate from the mass and the shorter the cooling time. For example, when an amount of fibrous material has the shape of a pyramid- or cone-shaped heap, it will cool down faster under the same conditions than the same amount shaped as a block. Furthermore, starting temperature of the fibrous material before cooling and exact target end temperature also impact total cooling time. Pressure applied in the cooling chamber of the vacuum cooler has some influence too: the lower this pressure, the faster the cooling process. As indicated above, pressures in the vacuum cooling chamber of 15 mbar or below, suitably in the range of from 6 to 11 mbar, give good results. The skilled person will be adjust the shape of the mass of fibrous material (and hence surface/volume ratio) and pressure applied to ensure average cooling rate will be within the range indicated hereinbefore.

The fibrous material to be cooled will generally be placed in means that can contain the mass of fibrous material and can allow moisture to escape (“containing means”). Suitable containing means include, for example, a container, a crate, a box or a bag (suitably made of a moisture-resistant material such as plastic), possibly placed in a crate. The containing means are suitably closable by closing means that prevent contamination of the fibrous material by foreign particles but at the same time allow moisture to escape from the fibrous material. For example, when using a container, crate or box, suitable closing means include a lid or foil having small holes in it, suitably microholes. Likewise, when a (plastic) bag is used, the mass of fibrous material may be covered with a foil having microholes while the bag may be loosely closed leaving sufficient space for the moisture to leave the bag through the foil. After cooling the lid or foil with the microholes is suitably removed from the containing means and such means is then suitably closed by water-impermeable closing means, e.g. by a closed lid (container, box, crate) or by closing the plastic bag, to make sure the dried fibrous material cannot be contaminated. Alternatively, it would also be possible to close the containing means by closing means (e.g. lid or foil for crate, box or container; tape, clip or other closure means for plastic bag) which are water-impermeable provided there is sufficient space left inside the containing means between the fibrous material and the closing means, so that any water that evaporates from the fibrous material can condense on the inside of the containing means or on the inside of the closing means, if feasible. After cooling the condensed moisture then is removed before closing the containing means. Alternatively, the dried fibrous product is transferred to another closable containing means for further transportation or handling.

In step (a) of the present process a homogenous mixture of protein material comprising milk protein material, a hydrocolloid which precipitates with metal cations, and water in the presence of a calcium complex-forming agent is formed at a temperature of between 50° C. and 90° C. The protein material used anyhow comprises milk protein material, but may also comprise additional non-milk protein material, notably plant-based protein material, such as e.g. soy protein or protein originating from chickpeas or lentils. Any reference to “milk protein material” in this context refers to products or materials that contain proteins derived from cow's milk. Suitable milk protein materials thus include cheese curd (i.e. curd prepared in cheesemaking), cheese, whey protein, whey protein concentrate, whey protein isolate, milk protein concentrate, powdered milk, micellar casein isolate, any caseinate, such as sodium or ammonium caseinate, and any combination of two or more of these milk protein materials. For the purpose of the present invention it was found particularly suitable that the milk protein material is selected from a curd from cheesemaking, cheese, powdered milk, micellar casein isolate (MCI), whey protein and caseinate, with a curd from cheesemaking being the most preferred milk protein material.

Such a curd can be the customary curd formed in cheese making, such as, for example, Maasdam or Gouda-type curd; advantageously, however, skimmed milk with a fat content of at most 0.15% by weight (based on total weight of skimmed milk) is used as the starting material for forming the curd that is used in the method according to the present invention. This raw material forms the basis for the fibrous product and ultimately the meat substitute product which suitably has a fat content of between 0 and 10% by weight, suitably between 2 and 10% by weight, based on total weight of product. When using skimmed milk as the starting material, fat content can adjusted to the desired level by adding a fat source, such as cream, anhydrous milk fat (AMF), an AMF fraction, butter, butter oil, a vegetable fat or a mixture of two or more of these fat sources. Cream would be preferred and for a full vegetarian variant a vegetable fat would be particularly suitable. In a typical process for preparing the curd a bactofugation or microfiltration step is incorporated so that the milk used is substantially free from bacteria. With regard to the formation of the curd, use can, of course, be made of the coagulants (e.g. microbial rennet) and starter materials (typically lactic acid bacteria) normally used when forming curd in cheese making. Curd prepared using microbial rennet which subsequently forms the basis for the fibrous product and hence the final meat substitute product is particularly suitable for use in Kosher or Halal type foods as well as in foods of a vegetarian nature.

When using a different milk protein material such as MCI as the starting material, fat content can also be adjusted to the desired level by adding a fat source as described above.

The hydrocolloid to be used is a hydrocolloid which precipitates with metal cations typically is a polysaccharide that precipitates by forming metal bridges between the polysaccharide molecules upon addition of the metal cations. In this way a structure is formed that encloses the milk protein parts. Suitable hydrocolloids include pectin with a low methoxyl group content, gellan gum and alginates, the latter being preferred, in particular sodium alginate. The hydrocolloid should be added in such amount that the aforesaid structure formed can enclose all milk protein parts present in the homogenous mixture. Typically, the amount of hydrocolloid used will be in the range of 1 to 5% by weight, based on total weight of the homogenous mixture, typically 1.5 to 3.5% by weight. The hydrocolloid is suitably added in the form of an aqueous solution, although addition is a different form, such as a powder, may also be possible.

The calcium complex-forming agent enables the formation of a homogenous mixture of all components added by forming complexes with the free calcium ions that are inevitably present in the milk protein material. It is important that all free calcium ions are somehow bound before adding the solution of a metal cation with a valency of at least 2 in step (b) in order to enable the formation of fibers in a controlled way. Suitable calcium complex-forming agents and the amounts in which they can be used are described in EP 1467628 B1. Particularly suitable calcium complex-forming agent are phosphate materials, such as alkali metal or ammonium salts of phosphoric acid or polyphosphoric acid, e.g. disodium hydrogenphosphate, trisodium phosphate, sodium hexametaphosphate or sodium polyphosphate. Such phosphate materials, and in particular sodium hexametaphosphate, are for example included in melting salts used in the cheese industry to replace calcium ions bound to the casein with sodium ions to loosen the casein proteins and make them water-soluble. The amount of phosphate material to be used typically is in the range of 0.1 to 1.5% by weight based on total weight of the homogenous mixture.

Step (a) as described above can be carried in various ways as long as the end result is a homogenous mixture of all components. In a preferred embodiment step (a) comprises the sub-steps of
(a1) preparing a mixture of the protein material, the calcium-complex forming agent and water;
(a2) heating the mixture resulting from step (a1) to a temperature between 50 and 90° C.; and
(a3) adding the hydrocolloid and mixing to obtain the homogenous mixture.

In step (a1) the calcium-complex forming agent and water are typically added to the protein material, i.e. the milk protein material and possibly one or more additional plant-based protein materials. Optionally a fibrous plant-based material may be added too in order to enhance the consistency of the mixture and of the final fibrous product. Examples of a suitable plant-based fibrous material include oat fiber, soy protein and chickpeas. Such plant-based material would typically be added in such amounts that in the final fibrous product total amount of plant-based material does not exceed 10% by weight based on total weight of fibrous product and suitably amounts to at most 5% by weight. The mixture is subsequently heated in step (a2) to a temperature of between 50° C. and 90° C., suitably not higher than 85° C., for sufficient time to ensure complete melting of the protein material. This will enable an efficient mixing in step (a3) upon addition of the hydrocolloid, so that a homogenous mixture of all components is obtained. In a preferred embodiment the mixture from step (a1) is melted completely in step (a2) by increasing the temperature to 65° C. or higher, suitably between 70 and 85° C., maintaining such high temperature until the protein material has melted completely and subsequently cooling back the liquid mixture to a temperature between 50 and 65° C. before adding the hydrocolloid in step (a3). We found that such temperature profile eventually results in excellent fibers. During step (a) the pH is suitably kept at a value between 4 and 7. The pH can be controlled by adding a base solution, suitably an aqueous sodium hydroxide solution during any one of steps (a1), (a2) or (a3).

In step (b) a solution of a metal cation with a valency of at least 2 is added to the mixture obtained in step (a) in order to form the fibrous product. By adding this solution milk protein/hydrocolloid fibers are formed, as the metal cation forms bridges between the hydrocolloid molecules, thereby enclosing milk protein particles in the resulting network. The metal cation solution suitably contains dissolved calcium or magnesium salts or mixtures of such salts. Particularly suitable salts are calcium chloride, calcium acetate or calcium gluconate with calcium chloride being preferred. Hence, the preferred solution of a metal cation with a valency of at least 2 is an aqueous solution of a calcium salt, preferably an aqueous solution of calcium chloride, so that the preferred metal cation with a valency of at least two is a calcium cation.

The metal cation solution is typically added to the homogenous mixture resulting from step (a) at a temperature of at least 50° C., suitably at the same temperature at which the homogenous mixture is obtained at the end of step (a), most suitably at a temperature of between 50 and 65° C. Mixing takes place for sufficient time to allow formation of the fibrous product, which will usually not exceed 1 hour and typically is in the range of 2 to 30 minutes, suitably 5 to 20 minutes.

After formation of the fibrous product, this product is isolated in step (c). This can be done by ways known in the art. In a suitable embodiment the fibrous product obtained in step (b) is first drained to remove any whey protein present and is subsequently washed one or more times with water to remove any further whey protein. The fibers may then be pressed to remove further liquid. Optionally, the fibrous product thus obtained may be packaged before subjecting it to cooling in step (d). During isolation step (c) the temperature of the fibrous product may decrease relative to the temperature of the fibrous product resulting from step (b). Accordingly, the temperature of the fibrous product may drop during isolation step (c) to as low as 30° C., although typically the temperature of the fibrous product after isolation step (c) will be at least 35° C. and may be as high as the temperature of the product leaving step (b), although a temperature of at most 50° C. would be preferred. Hence, the temperature of the isolated fibrous product after step (c) before cooling step (d) may suitably be in the range of 35° C. to 50° C.

Finally the fibrous product is cooled in step (d) to a temperature below 10° C. by vacuum cooling as described above resulting in the cooled fibrous product. This cooled product is then suitably further processed into the final meat substitute product by ways known in the art. This may involve adding binder materials, herbs, spices and other ingredients depending on the type and taste of meat substitute product desired. For example, WO 2006/009426 A1 discloses the addition of a specific binder material to the fibrous product when further processing the fibrous product into the final meat substitute product. According to WO 2006/009426 A1 this binder material gels upon heating and is selected from methylcellulose, hydroxypropylmethylcellulose, curdlan gum, konjac gum, chicken egg protein, whey protein and mixtures of two or more of these binders. Further processing may also involve heating in a microwave, baking in a pan, welling or deep-frying before consumption in order to render the product in another desirable attractive state. After such treatment the product may be consumed directly or be frozen and packaged to be consumed later. The present invention, accordingly, also relates to use of the fibrous product obtained by the process described hereinbefore for the preparation of a meat substitute product.

The invention is illustrated by the following examples without limiting the scope of the invention to these specific embodiments.

### EXAMPLES

### Example 1—Preparation of Fibrous Material

A melting tank was filled with successively 270 liters of water, 37.5 kg of oat, 2700 kg of Gouda-type cheese curd cut into small pieces and 46 kg of melting salt predominantly consisting of sodium hexametaphosphate and the temperature was raised to about 50° C. before adding 24 liters of a 25% by weight sodium hydroxide solution in water. The curd used was prepared in the conventional way from skimmed milk having a fat content of 0.1% by weight and total protein content of 4.3% by weight, based on total weight of skimmed milk. Temperature in the melting tank was subsequently raised to 74° C. and this temperature was maintained for 35 minutes until all curd was melted and a liquid, melted mass was obtained. The melted mass was subsequently cooled back to 58° C. pH of the melted mass was 6.9 (determined according to NEN 3775)

1000 kg of the melted mass was transferred to a paddle mixer (preheated to 58° C.) and 500 kg of an sodium alginate solution in water (containing 4.2% by weight sodium alginate based on total weight of the solution) was added. The melted mass and alginate solution were mixed at 58° C. for 5 minutes to form a homogenous paste-like mixture. To this mixture 420 kg of a calcium chloride solution was added (containing 4.43% by weight of CaCl₂ based on total weight of solution) by spraying it into the paddle mixer under continuous stirring. After all calcium chloride solution was added the mixing continued for another 12 minutes, thereby forming fibrous material having a temperature of approximately of 58° C.

The fibrous material formed was subsequently isolated by draining approximately 20% by weight of the total mass of fibrous material. Then the fibrous material was washed by adding 375 liters of water and after all water was added stirring was started again and continued for 30 seconds, after which the resulting mixture was drained again until no more liquid was released. 200 kg of the resulting fibrous material having a temperature of about 40° C. were put in a plastic bag in a crate in the form of a single cone-shaped heap, a temperature sensor was placed inside the heap, the heap was covered with a foil having microholes and the upper side of the plastic bag was loosely folded to partially close the bag, so that moisture from the fibrous material could still leave the bag through the foil during cooling. The crate with the loosely folded plastic bag was placed in the cooling chamber of a vacuum cooler and the pressure in the cooling chamber was reduced to 8 mbar. After 30 minutes the vacuum was lifted and the crate was removed from the vacuum cooler. The fibrous material obtained had a temperature of 4° C. Cooling rate thus amounted to 25 s/10 kg/10° C. The foil was removed and the plastic bag was closed.

### Example 2—Preparation of Comparative Fibrous Material

Example 1 was repeated until the cooling step. To achieve cooling 200 kg of the fibrous material having a temperature of about 42° C. after the isolation step were put in a plastic bag in a crate in the form of a single cone-shaped heap, a temperature sensor was placed inside the heap and the bag was closed. The crate with the closed plastic bag was cooled by air blast cooling by placing it in a cooling cell and blowing air of 4° C. over the plastic bag containing fibrous material. It took 10 hours to cool down the fibrous material to about 4° C., which means the cooling rate amounted to 7.9 minutes/10 kg/10° C. Moisture droplets formed on the inside of the plastic bag during cooling, indicating that moisture left the fibers during cooling.

### Example 3—Shelf-Life Test

The fibrous materials of Examples 1 and 2 were tested for enumeration of culturable micro-organisms by determining Total Plate Count (TPC) in cpu/g at 22° C., 24 hours after completion of the final cooling step, in accordance with standard method ISO 6222:1999 (as last reviewed and confirmed in 2015).

The results are indicated in Table 1.

TABLE 1
TPC at 22° C. of fibrous materials

| Sample | TPC (cfu/g) | ¹⁰log(TPC) |
|---|---|---|
| Example 1 | 1300 | 3.1 |
| Example 2 | 77,100 | 4.9 |

As can be seen from Table 1 the vacuum cooled fibrous material prepared in accordance with the process of the invention shows a much lower bacterial count than the fibrous material prepared using conventional air blast cooling and hence the vacuum cooled fibrous material has a better shelf-life than the conventionally cooled material.

1. Process for the preparation of a fibrous product comprising protein, which process comprises the steps of:
(a) preparing a homogenous mixture of protein material comprising milk protein material, a hydrocolloid which precipitates with metal cations, and water in the presence of a calcium complex-forming agent at a temperature between 50° C. and 90° C.;
(b) adding a solution of a metal cation with a valency of at least 2 to the mixture obtained in step (a) in order to form the fibrous product;
(c) isolating the fibrous product; and
(d) cooling the fibrous product,
wherein in step (d) the fibrous product is cooled to a temperature below 10° C., by vacuum cooling.

2. Process according to claim 1, wherein the conditions of vacuum cooling in step (d) are such that the average cooling rate of the fibrous material is in the range of from 8.5 to 35 s/10 kg/10° C.

3. Process according to claim 1, wherein step (a) comprises the sub-steps of:
(a1) preparing a mixture of the protein material, the calcium-complex forming agent and water;
(a2) heating the mixture resulting from step (a1) to a temperature above the melting temperature of the mixture; and
(a3) adding the hydrocolloid and mixing to obtain the homogenous mixture.

4. Process according to claim 1, wherein the milk protein material is selected from a curd from cheesemaking, cheese, powdered milk, micellar casein isolate (MCI), whey protein and caseinate.

5. Process according to claim 1, wherein the hydrocolloid is an alginate.

6. Process according to claim 1, wherein the calcium-complex forming agent is a phosphate material.

7. Process according to claim 1, wherein the solution of a metal cation with a valency of at least 2 is an aqueous solution of a calcium salt.

8. A meat substitute product comprising the fibrous product obtained by the process according to claim 1.

9. Process according to claim 1, wherein in step (d) the fibrous product is cooled to a temperature between 0 and 7° C. by vacuum cooling.

10. Process according to claim 4, wherein the milk protein material is a curd from cheesemaking.

11. Process according to claim 5, wherein the alginate is sodium alginate.

12. Process according to claim 7, wherein the aqueous solution of the calcium salt is an aqueous solution of calcium chloride.
